(19) United States
(12) Patent Application Publication
(10) Pub. No.: US 2006/0100003 A1
(43) Pub. Date: May 11, 2006

(54) Folding type electronic device

(75) Inventors: Katsushige Kohri, Osaka (JP); Katsumi Adachi, Kato (JP); Shigehiro Fujii, Kato (JP); Yoshito Fukata, Kato (JP); Junji Wakihara, Kato (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 10/525,813

(22) PCT Filed: Aug. 25, 2003
(86) PCT No.: PCT/IB03/03483

§ 371 Date: Sep. 9, 2005

(30) Foreign Application Priority Data
Aug. 30, 2002 (JP) 2002-255181
Jan. 15, 2003 (JP) 2003-007022

(51) Int. Cl. H04M 1/00

(52) U.S. Cl. 455/575.1; 455/550.1

(57) ABSTRACT

A folding-type electronic device, such as a portable telephone, is provided with a functional component such as a switch that a user can operate regardless of whether the device is in the opened state or in the closed state, without increasing the number of parts and without expanding the mounting space. The functional component, such as a rotation switch 5, is mounted on the space between a pair of bearing mechanisms 4 that are provided between the main casing 2 and the sub-casing 3. The user can access and operate the functional component, either when the device is in an opened state or in a closed state.

### TECHNICAL FIELD

The present invention relates to a folding-type electronic device, and relates, more particularly, to a folding-type portable telephone that has a hinge (i.e., an opening and closing mechanism).

The folding-type portable telephone has a first casing (i.e., a main casing) that mainly accommodates an operating section, and a second casing (i.e., a sub-casing) that mainly accommodates a display. The first casing and the second casing are connected with a hinge, and are opened and closed around the hinge. As this structure is convenient for using the telephone, the demand for this folding-type portable telephone shows a remarkable increase every year. Along the increase in the demand for this folding-type portable telephone, there is also a request for realizing the same function having a predetermined purpose regardless of whether the telephone is in the opened state or the closed state.

### BACKGROUND OF ART

Conventionally, a folding-type portable telephone has a functional component such as a switch mounted individually on the front surface and on the back surface respectively of the telephone in order to achieve the same function regardless of whether the telephone is in the opened state or the closed state. Therefore, the telephone requires a plurality of switches having the same function. In the normal using state of the telephone, it is convenient to operate the telephone on the same surface as the console panel where buttons and keys are mounted inside the telephone. Therefore, a functional component such as the switch is disposed inside the telephone. In the non-using state of the telephone, the telephone is folded, and it is not possible to use the same switch disposed inside the telephone. Therefore, it has been necessary to provide another switch having the same function at the outside of the telephone.

There are the following prior art publications that disclose the improvement in the structure of the hinge of the conventional folding-type portable telephone.

Japanese Laid-open Patent Publication (Kokai) No. 2001-203786 discloses an inbound connection communication system of a folding-type electronic device. In order to improve the operability of the electronic device, this communication system has a controller that detects an opening of a hinge when force is applied to the hinge to such an extent that the casing is opened in excess of an angle set for the using state. The controller starts communications at the call incoming time, based on this detection.

Japanese Laid-open Patent Publication (Kokai) No. 1-212052 discloses a folding-type portable telephone. This folding-type portable telephone comprises: a main casing that has at least a dial key section, a receiver, a communication circuit network, and a hook switch; a frame that has at least a transmitter, and is rotatably connected to the main casing such that the frame is folded back to the main casing during a non-communication time, and is extended to form a predetermined angle relative to the main casing during a communication time; a plurality of contacts that are provided in a state connected to the communication circuit network on the main casing, and that switches off an electric signal to the transmitter based on electric disconnection to the communication circuit network; and a conductive contact segment that is provided in the frame, is in contact with the contact points in the frame extended state, and is electrically connected to the frame. According to this folding-type portable telephone, an electric signal is connected to the transmitter when the frame is extended to the main casing by a predetermined angle in order to carry out communications. Until when the frame is extended, the electric signal to the transmitter is disconnected. Therefore, when the frame is extended, it is possible to prevent the transmitter from receiving voice from the receiver.

Japanese Laid-open Patent Publication (Kokai) No. 8-9005 discloses a folding-type portable telephone. This folding-type portable telephone detects a rotation angle of the hinge when the transmitter and the receiver are mutually closed or opened, and generates a control signal corresponding to this rotation angle. Based on this control signal, the folding-type portable telephone suppresses a change in the sound volume and noise attributable to a change in the rotation angle. At the same time, the folding-type portable telephone suppresses echo based on a change in an echo path attributable to a change in the rotation angle.

According to the above conventional techniques, the devices detect whether the folding-type portable telephone is in the opened state or the closed state, or detect an opened or closed angle, and operate the switch according to the opened state or the closed state. However, according to the conventional folding-type portable telephone, it has been extremely inconvenient to input a certain specific instruction to the telephone.

### DISCLOSURE OF THE INVENTION

It is accordingly an object of the present invention to provide a folding-type electronic device, such as a folding-type portable telephone, having a functional component that can be operated to achieve the same function regardless of whether the telephone is in the closed state or in the opened state.

It is another object of the present invention to provide a folding-type electronic device having a functional component such as a switch that can be operated both from the inside and the outside of the telephone, without increasing the number of parts and without increasing the mounting space.

It is still another object of the present invention to provide a folding-type electronic device that effectively utilizes the space of a hinge (i.e., an opening and closing mechanism).

The present invention thus provides a folding-type electronic device, such as a portable telephone, that solves the above problems by paying attention to the hinge.

In order to achieve the above objects, the present invention provides a folding-type electronic device, such as a portable telephone that has a main casing and a sub-casing openably and closably coupled with each other via a hinge, wherein the hinge is mounted with a functional component, and it is possible to operate the functional component regardless of whether the electronic device is in the opened state or in the closed state.

According to the present invention, as the functional component is mounted on the hinge, it is possible to operate the functional component regardless of whether the electronic device is in the opened state or in the closed state. Further, it is possible to expand the mounting space or effectively utilize the space of the hinge, without increasing the number of parts.

The functional component is mounted on the hinge so that the functional component can rotate coaxially with the hinge axis. Specifically, the hinge has a pair of bearing mechanisms that include a pair of bearings coaxially provided, with a distance between the two bearing mechanisms, on one of a main casing and a sub-casing, and a pair of shaft members coaxially provided, with a distance between the two shaft members, on the other of the main casing and the sub-casing, and engaged with the bearings respectively. The functional component is mounted in the space between the pair of bearing mechanisms.

The functional component is disposed in the space between the pair of bearing mechanisms and is supported rotatably and also movably in an axial direction, or is supported rotatably or movably in an axial direction, on a pair of second bearings provided with a distance on one of the main casing and the sub-casing.

The functional component is a rotation switch that is rotatably supported on the pair of second bearings within at least a constant angular range.

The functional component may be an electric element, such as a rotation switch, or the functional component may be a communication unit for infrared data communications (based on the Infrared Data Association (IrDA) standard) or the like, or a camera, or an optical part such as a terminating light-emitting diode (LED), or an acoustic part such as a speaker.

### BRIEF DESCRIPTION OF THE DRAWINGS

FIGS. 1A to 1C are schematic views of a folding-type portable telephone according to an embodiment of the present invention, where FIG. 1A shows a state that the folding-type portable telephone is opened, and FIG. 1B and FIG. 1C show a state that the folding-type portable telephone is closed;

FIG. 2 is a top plan view of the folding-type portable telephone according to the present invention, showing a state that the hinge is opened by about 180 degrees;

FIG. 3 is a side view of the folding-type portable telephone according to the present invention, showing a state that the hinge is opened by about 180 degrees;

FIG. 4 is a side view of the folding-type portable telephone according to the present invention, showing a state that the hinge is completely closed;

FIG. 5 is a schematic view of the folding-type portable telephone in the opened state according to an embodiment of the present invention;

FIG. 6 is a top plan view of the folding-type portable telephone shown in FIG. 5;

FIG. 7 is a cross-sectional view of the folding-type electronic device cut along a line A-A in FIG. 6;

FIG. 8 is an enlarged cross-sectional view of the folding-type electronic device cut along a line B-B in FIG. 6;

FIG. 9 is a perspective view of a hinge structure of the folding-type portable telephone shown in FIG. 5;

FIG. 10 is a perspective view of a stopper structure of the folding-type portable telephone shown in FIG. 5;

FIG. 11 is a perspective view of a rotation operation of a switch of the folding-type portable telephone shown in FIG. 5; and

FIG. 12 is a schematic view of the folding-type portable telephone shown in FIG. 5, where the folding-type portable telephone is mounted with electric parts.

### BEST MODE FOR CARRYING OUT THE INVENTION

An embodiment of the present invention will be explained below with reference to the accompanying drawings.

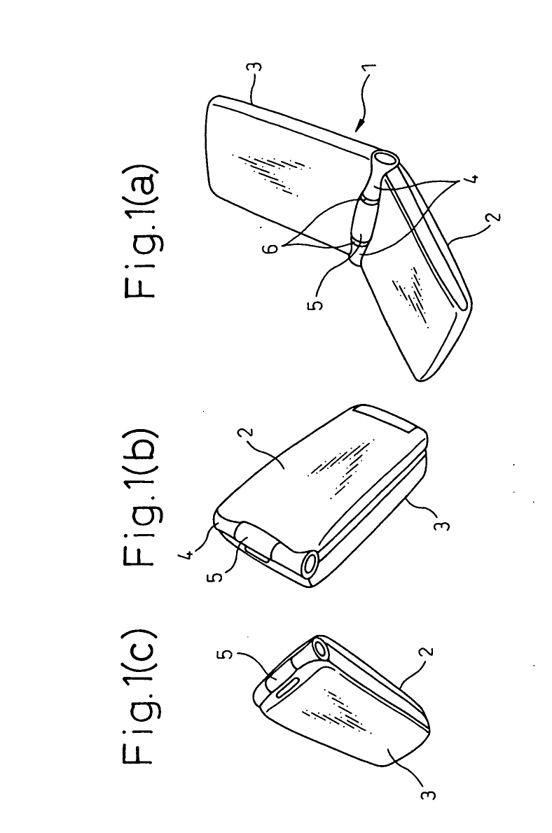

FIGS. 1A to 1C are schematic views of a folding-type portable telephone according to the embodiment of the present invention. A folding-type portable telephone 1 has a first casing (i.e., a main casing) 2 that accommodates an input console panel on which various kinds of buttons and a mouthpiece are mounted, and a second casing (i.e., a sub-casing) 3 that accommodates a liquid crystal display, and a receiver. The first casing 2 and the second casing 3 are connected with a hinge 4 such that these casings can be opened and closed around the hinge 4.

During the use of the folding-type portable telephone 1, the telephone 1 is in the opened state, as shown in FIG. 1A, and a user transmits and receives messages and carries out communications in this state. When the telephone 1 is in the opened state, a stopper not shown in FIGS. 1A to 1C restricts the opening between the main casing 2 and the sub-casing 3 to be once fixed to about 165 degrees as a normal opened angle.

During the non-use period of the folding-type portable telephone 1, the telephone 1 is in the closed state as shown in FIG. 1B and FIG. 1C, which is convenient for accommodating the telephone 1. When the telephone 1 is in the closed state, the opening angle between the main casing 2 and the sub-casing 3 becomes approximately zero degree. The main casing 2 has displays both on the front surface and on the back surface thereof, and the user can select the front surface display or the back surface display to be looked at, according to the opened or closed state of the telephone 1.

The hinge 1 consists of a pair of bearing mechanisms. In other words, the hinge 1 includes a pair of bearings coaxially provided with a distance therebetween at one end of the main casing 2 at the sub-casing 3 side, and a pair of shaft members coaxially and symmetrically provided with a distance therebetween at one end of the sub-casing 3 at the main casing 2 side. The pair of shaft members are rotatably engaged with the pair of bearings respectively.

The hinge 4 is provided with the stopper mechanism not shown in FIG. 1A to FIG. 1C as described above. The stopper mechanism is structured to maintain the closed state when the main casing 2 and the sub-casing 3 are in the closed state, and maintain the opened state when the main casing 2 and the sub-casing 3 are in the opened state at a predetermined angle therebetween.

Contrary to the above structure, the pair of bearing mechanisms that constitute the hinge 4 may also be so arranged that the bearings are provided at the sub-casing 3 side, and the shaft members, which are engaged with these bearings, are provided at the main casing 2 side.

Space is prescribed between the pair of bearing mechanisms that constitute the hinge 4. According to the embodiment of the present invention, a rotation switch 5 is rotatably mounted coaxially with inspect to the hinge axis, in this space. This rotation switch 5 is rotatably supported within at least a predetermined angular range by a pair of bearing members 6 that are provided with a distance on one of the main casing 2 and the sub-casing 3, in the space between the pair of bearing mechanisms 4.

The rotation switch 5 is rotatably provided coaxially with the hinge axis on the hinge 4 that openably and closably connects the main casing 2 and the sub-casing 3. Therefore, when the portable-type telephone 1 is in the opened state as shown in FIG. 1A, the rotation switch 5 is also in the exposed state like the hinge 4 inside the opened telephone 1. Consequently, it is possible to operate the rotation switch 5 from the inside of the telephone 1 in the same manner as it is possible to operate the console section provided with the buttons and keys inside the main casing 2 of the telephone 2.

On the other hand, when the portable telephone 1 is in the folded state by closing the portable telephone 1 as shown in FIG. 1B and FIG. 1C, the rotation switch 5 is exposed to the outside of the telephone 1 in the same manner as the hinge 4. Therefore, when the telephone 1 is in the folded state, it is also possible to operate the rotation switch 5 from the outside of the telephone 1. As explained above, it is possible to operate the same rotation switch 5 both from the inside and the outside of the telephone 1, regardless of whether the portable telephone 1 is in the opened state or in the closed state.

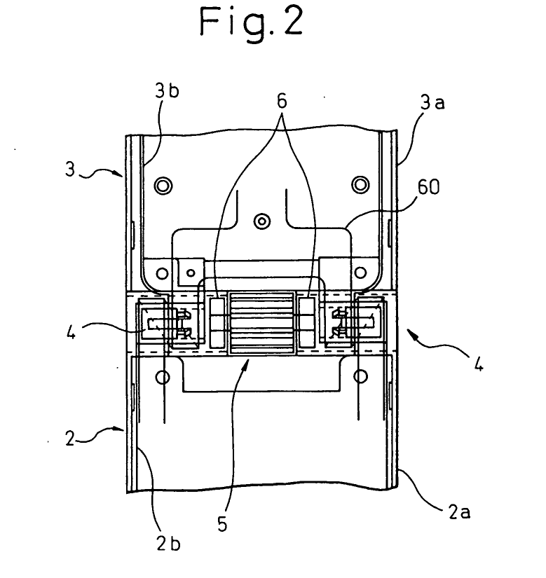

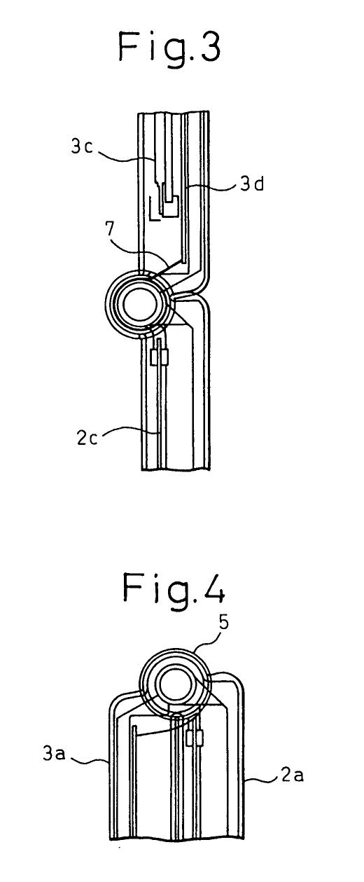

FIG. 2 is a top plan view of the folding-type portable telephone according to the present invention, showing a state that the hinge is opened by about 180 degrees. FIG. 3 is a side view of this folding-type portable telephone in an opened state-similar to FIG. 2, and FIG. 4 is a side view of this folding-type portable telephone showing a state that the hinge is closed.

The main casing 2 has a key-side case 2a at the outside, and has a key-side magnesium chassis 2b at the inside of this key-side case 2a, and incorporates a key-side printed substrate 2c. The sub-casing 3 has a liquid crystal display (LCD) side case 3a at the outside, and has an LCD-side magnesium chassis 3b at the inside of this LCD-side case 3a, and incorporates a liquid crystal display (LCD) 3c. An LCD-side printed substrate 3d is provided at the lower side of the LCD 3c, that is, in the space between the LCD 3c and the LCD-side magnesium chassis 3b.

The main casing 2 and the sub-casing 3 are connected to each other via a flexible printed circuit board (FPC) 60 across the hinge 4. One end of the FPC 60 is connected to the key-side printed substrate 2c of the main casing 2, and the other end of the FPC 60 is connected to the printed substrate 3d of the sub-casing 3. Therefore, the FPC 60 electrically connects between the main casing and the sub-casing regardless of whether the telephone is in the opened state or the closed state.

As explained above, the hinge 4 consists of a pair of bearing mechanisms disposed with a distance between the two bearing mechanisms. In this space, the rotation switch 5 is rotatably provided coaxially with the hinge axis. The rotation switch 5 is rotatably fitted within at least a predetermined angular range on the pair of bearings 6 that are disposed at both sides of the space between the pair of bearing mechanisms 4. It is possible to fix these bearings 6 to the case 2a of the main casing 2 or the case 3a of the sub-casing 3.

The rotation switch 5 may be any type of switch such as an ON/OFF switch, an analog switch, or the like. This switch mechanism may be in such a structure that a fixed side micro switch is physically turned ON or OFF based on the rotation of a rotation unit, for example. Alternatively, the mechanism may be in a structure to optically detect the rotation of a rotation unit.

When the telephone is in the opened state, approximately a half of the external periphery of the rotation switch 5 is exposed to the inside of the telephone, and approximately the rest half of the external periphery faces the structure unit of the casing, as shown in FIG. 3. Therefore, in this state, it is possible to operate the rotation switch 5 from the inside of the telephone. On the other hand, when the telephone is in the closed state, approximately a half of the external periphery of the rotation switch 5 is exposed to the outside of the telephone. Therefore, in this state, it is possible to operate the rotation switch 5 from the outside of the telephone.

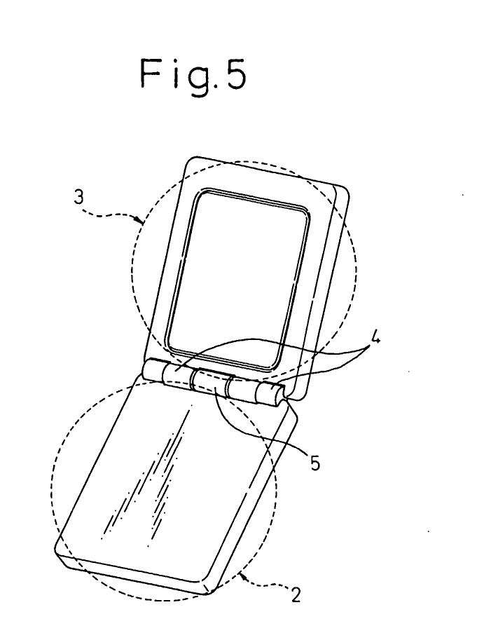

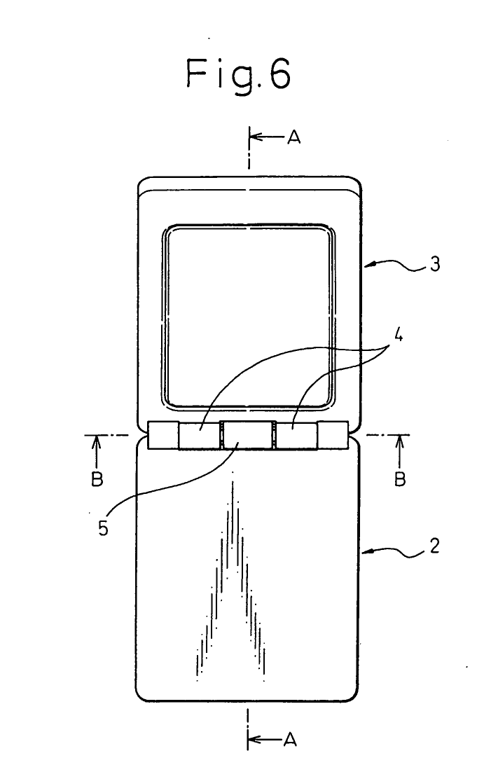

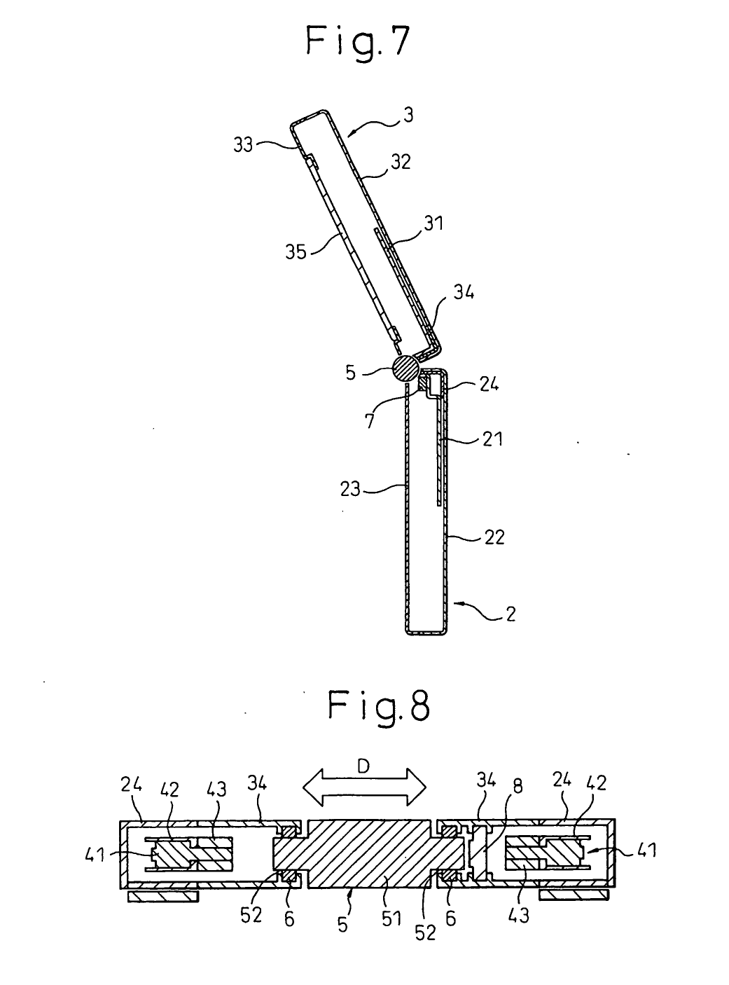

FIG. 5 to FIG. 8 show a more concrete state of the folding-type portable telephone according to the embodiment of the present invention. FIG. 5 is a schematic view of the folding-type portable telephone in the opened state. FIG. 6 is a top plan view of the folding-type portable telephone according to the present embodiment. FIG. 7 is a cross-sectional view of the folding-type electronic device cut along a line A-A in FIG. 6. FIG. 8 is an enlarged cross-sectional view of the folding-type electronic device cut along a line B-B in FIG. 6.

In these drawings, the main casing (the key side-casing) 2 consists of a key-side chassis 21, a key-side rear case 32, a key-side front case 23, a key-side hinge cover 24, and the other elements. The key-side printed circuit board (2c in FIG. 3) inside the main casing is not shown in the drawings. The sub-casing (the LCD side-casing) 3 consists of a liquid crystal display (LCD) side chassis 31, an LCD-side rear case 32, an LCD-side front case 33, an LCD-side hinge cover 34, a liquid crystal display (LCD) panel 35, and the other elements. The LCD-side printed substrate (3d in FIG. 3) inside the sub-casing is not shown in the drawings.

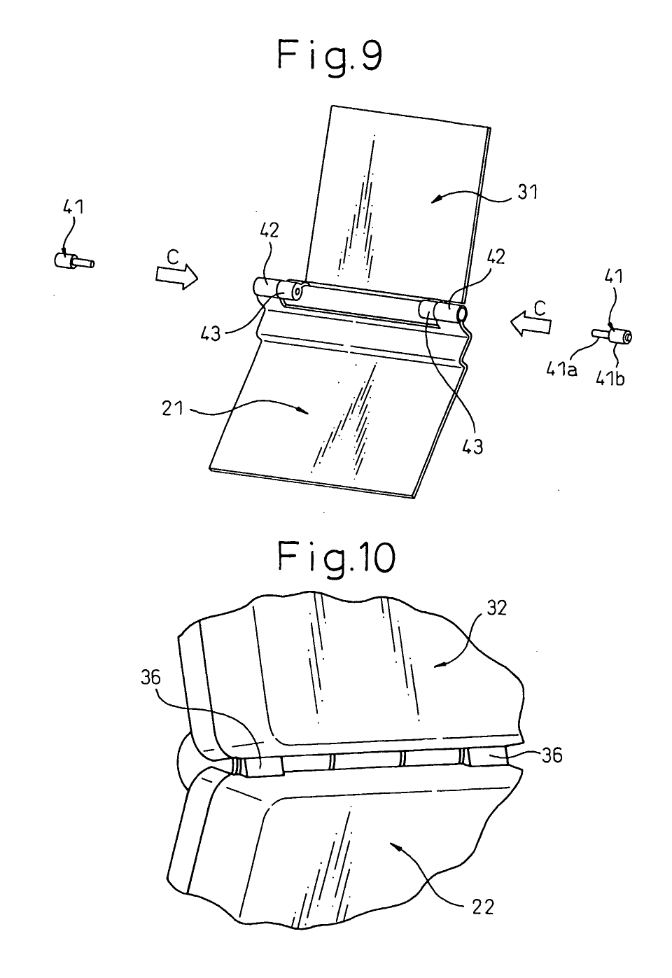

FIG. 9 is a perspective view of the hinge structure of the folding-type portable telephone shown in FIG. 5. The key-side chassis 21 is manufactured based on die casting, using a material like magnesium. At portions near both ends of the chassis 21 end at the LCD side, a pair of cylinders 42 and 42 into which a pair of hinge pins 41 and 41 are to be inserted, are integrally formed coaxially in an axial direction with a distance between the two cylinders. On the other hand, at the key-side end of the LCD-side chassis 31, a pair of cylinders, that is, bearings 43 and 43, adjacent to the inside of the pair of cylinders 42 and 42, are integrally formed coaxially in an axial direction with a distance between the two bearings.

Each hinge pin 41 is formed based on a coaxial integration of a shaft portion 41a having a small external diameter, and a shaft portion 41b having a large external diameter. Each hinge pin 41 is inserted, with the small-diameter shaft portion 41a inside, into each cylinder 42 at the key-side chassis 21, from the outside in a direction of an arrow mark C shown in FIG. 9. Based on this, the large-diameter shaft portion 41b is engaged with the inside of the cylinder 42. On the other hand, the small-diameter shaft portion 41a is rotatably engaged with the bearing 43 of the LCD-side chassis 31. Consequently, the key-side chassis 21 and the LCD-side chassis are connected to each other with the hinge.

The main portion of the key-side chassis 21 forms a flat portion. The key-side rear case 22 that constitutes an external wall beneath the key-side chassis 21 is fixed to this chassis 21. The key-side front case 23 constitutes an upper external wall. The key-side hinge cover 24 that covers the hinge is fixed to the key-side rear case 22. (The key-side hinge cover 24 may be fixed to the front case side.) Similarly, the main portion of the LCD-side chassis 31 also forms a flat portion. The LCD-side rear case 32 that constitutes an external wall beneath the LCD-side chassis 31 is fixed to this chassis 31. The LCD-side front case 33 constitutes an upper external wall. The LCD-side hinge cover 34 that covers the hinge is fixed to the LCD-side rear case 32. (The LCD-side hinge cover 34 may be fixed to the front case side.)

FIG. 10 is a perspective view of a stopper structure of the folding-type portable telephone shown in FIG. 5. A pair of stoppers 36 and 36 are integrally provided at both sides of the LCD-side end of the key-side rear case 32 so that these stoppers project to the LCD side. When the telephone is opened around the hinge 4, the stoppers 36 and 36 are brought into contact with the key-side end of the LCD-side rear case 22, and restrict the angle between the main casing 2 and the sub-casing 3 to a constant opened state. For example, the stoppers 36 restrict the internal angle between the main casing 2 and the sub-casing 3 to be maintained, for example, at 165 degrees. In the present embodiment, while the pair of stoppers 36 and 36 are provided on the key-side rear case 32, it is also possible to provide these pair of stoppers on the LCD-side rear case 22, on the contrary. When the telephone is opened, the stoppers may be brought into contact with the key-side end of the key-side rear case 32. While a pair of stoppers are provided in the present embodiment, it is also possible to provide one stopper at the center of the end portion of the LCD-side rear case 32 or the key-side rear case 22. Based on this, it is possible to restrict the angle of the telephone in the opened state.

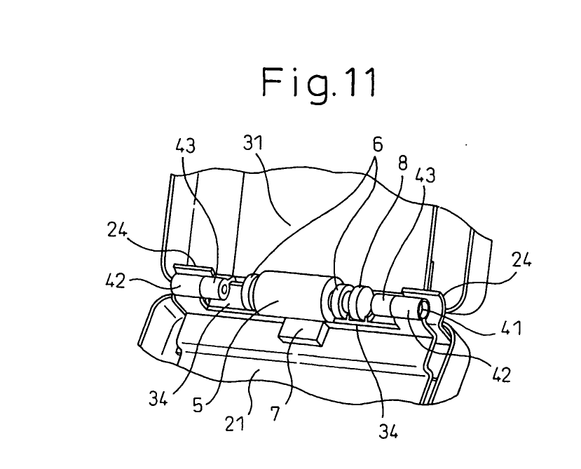

FIG. 11 shows a rotation operation mechanism of the rotation switch. Space is prescribed between the pair of bearing mechanisms 42 and 42 that constitute the hinge of the telephone, that is, between the pair of bearings 43 and 43 (FIG. 9) on the LCD-side chassis 31. The rotation unit 5 is rotatably provided coaxially with the hinge axis, in this space. As shown in the cross-sectional view in FIG. 8, this rotation unit 5 has a portion 51 having a large external diameter at the center, and portions 52 and 52 having small external diameters at both ends. The small-diameter portions 52 and 52 at both ends are rotatably supported by the bearings 6 and 6.

On the other hand, a rotation detection sensor 7 is fixed to the center of the hinge side end of the key-side chassis 22, at a position adjacent to the rotation unit 5. This sensor 7 detects a rotation of the rotation unit 5, and carries out a switch operation.

As shown by an arrow mark D in FIG. 8, the rotation unit 5 is supported movably in an axial direction within a predetermined range, as well as is rotatably supported by the bearings 6 and 6. For example, the rotation unit 5 moves to the right in an axial direction in FIG. 8, and the right end of the rotation unit 5 is brought into contact with a switch 8, thereby to turn ON or OFF the switch. The switch 8 may be a contact switch, or a micro switch, or other switch that can physically recognize ON and OFF when the rotation unit is brought into contact with the switch.

The key-side front case 23 is fixed to the key-side chassis 21, and covers the surrounding of the pair of cylinders 42 into which the pair of hinge pins 41 are inserted. On the other hand, the LCD-side hinge cover 34 is fixed to the LCD-side chassis 31, and covers the surrounding of the pair of bearings 43. The front case 23 and the hinge cover 34 are mutually smoothly continuous in the hinge axial direction. The LCD-side hinge cover 34 covers the surrounding of the pair of bearings 43, and, at the same time, holds the pair of bearings 6 and 6, and the switch 8. In other words, the pair of bearings 6 and 6 are fixedly held and maintained at the inside of the LCD-side hinge cover 34, by being sandwiched, or pressed in, or with a double-stick tape or the like. The switch 8 is similarly fixed and held at the inside of the LCD-side front case 33 and the LCD-side hinge cover 34 adjacent to the right-side bearing 6 in FIG. 8.

In the preset embodiment, the switch unit 5 is a rotation unit which is rotatable and is also movable in the axial direction. It is also possible to arrange such that the switch unit 5 cannot rotate in a rotation direction but can move only in an axial direction within a predetermined range, and achieves the switch function based on the move of the switch main body in the axial direction.

As shown in FIG. 8, at the portion where the key-side front case 23, the key-side hinge cover 24, the LCD-side front case 33, and the LCD-side hinge cover 34 cover the hinge, the external shape of this portion is formed smooth and continuous. This portion is coaxial with the rotation unit 5, and has approximately the same external diameter as that of the rotation unit 5. The move range of the rotation unit 5 in the axial direction is restricted based on the butting of the rotation unit 5 itself against the LCD-side front case 33 and the LCD-side hinge cover 34.

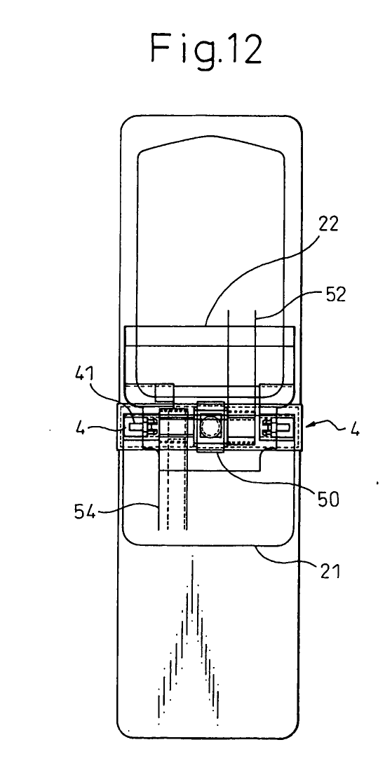

FIG. 12 shows a modification of the above embodiment where an electric element 50 is mounted in place of the rotation switch 5. The present modification is similar to the above embodiment except the rotation unit 5, the rotation detection sensor 7, and the rotation and slide operation mechanism of the rotation unit 5. For this electric element 50, it is possible to employ a part that achieves the function of a communication unit for infrared data communications (based on the Infrared Data Association (IrDA) standard) or the like, or a camera, or an optical part that achieves the optical function of light emission or light reception such as a terminating light-emitting diode (LED), or a part that achieves the acoustic function such as a speaker.

In FIG. 12, a reference numeral 52 denotes a flexible printed circuit board (FPC) that electrically connects between the main casing 2 and the sub-casing 3. A reference numeral 54 denotes a flexible printed circuit board (FPC) that electrically connects between the main casing 2 and the sub-casing 3, and also electrically connects the electric part 50. It is possible to form the electric part 50 on the FPC 54.

In both of the above embodiments and the modifications according to the present invention, the rotation switch 5 or the electric element 50 is mounted on the hinge as the rotation center of the telephone. When the telephone is in the opened normal using state, the rotation switch 5 or the electric element 50 is exposed on the hinge at the inside of the telephone on the same surface as the console panel where buttons and keys are mounted, during the use of the telephone like during communications. Therefore, it is possible to easily operate the rotation switch 5 or the electric element 50 from the inside of the telephone in the sense similar to the sense of operating the buttons and keys. When the telephone is in the closed normal non-using state, the rotation switch 5 or the electric element 50 provided on the hinge is exposed to the outside on the hinge at the outside of the telephone. Therefore, even during the normal non-using state, it is also possible to directly operate only the rotation switch 5 or the electric element 50 from the outside of the telephone.

As explained above, according to the present invention, it is possible to operate a functional component such as the rotation switch 5 or the electric element 50, regardless of whether the telephone is in the opened state or the closed state. As a result, it is possible to improve the operability and the functionality.

While the embodiment and the modification of the embodiment according to the present invention have been explained above with reference to the accompanying drawings, the present invention is not limited to them. It is also possible to employ various forms and carry out various modifications and corrections within a range not deviating from the gist of the present invention.

It should be understood by those skilled in the art that the foregoing description relates to only some of preferred embodiments of the disclosed invention, and that various changes and modifications may be made to the invention without departing from the spirit and scope thereof.

### INDUSTRIAL APPLICABILITY

As explained above, the folding-type portable telephone according to the present invention has a functional component mounted on the hinge. Based on this, it is possible to improve the operability of the telephone regardless of whether the telephone is in the opened state or the closed state. For example, a user can freely select whether to look at an electronic mail in the opened state or the closed state of the telephone, according to the scene of utilizing the telephone. It is possible to expand the mounting space without increasing the number of parts, and it is possible to effectively utilize the space of the hinge. As a result, it is possible to realize the folding-type portable telephone having high function and high density.

1. A folding-type electronic device that has a main casing and a sub-casing openably and closably coupled with each other via a hinge, wherein
the hinge is mounted with a functional component, and the electronic device enables a user to access the functional component and operate the functional component regardless of whether the electronic device is in the opened state or in the closed state.

2. A folding-type electronic device according to claim 1, wherein the functional component is mounted on the hinge coaxially with the hinge.

3. A folding-type electronic device according to claim 2, wherein the hinge has a pair of bearing mechanisms that comprise:
a pair of bearings coaxially provided, with a distance between the two bearing mechanisms, on one of a main casing and a sub-casing; and
a pair of shaft members coaxially provided, with a distance between the two shaft members, on the other of the main casing and the sub-casing, and engaged with the bearings respectively, and
the functional component is mounted in the space between the pair of bearing mechanisms.

4. A folding-type electronic device according to claim 3, wherein
the pair of bearings are formed on a chassis of one of the main casing and the sub-casing, and the pair of shaft members comprises a pair of hinge pins, which are fixed to cylinders formed on a chassis of the other of the main casing and the sub-casing,
each hinge pin has a large-diameter portion and a small-diameter portion integrally structured in an axial direction, and
the large-diameter portions are fixed to the cylinders respectively, and the small-diameter portions are engaged with a pair of second bearings respectively.

5. A folding-type electronic device according to claim 3, wherein
the functional component is disposed between the pair of bearing mechanisms and is rotatably supported by a pair of second bearings that are provided, with a distance therebetween, on one of the main casing and the sub-casing.

6. A folding-type electronic device according to claim 3, wherein
the functional component is disposed between the pair of bearing mechanisms and is movably supported in an axial direction by a pair of second bearings that are provided, with a distance therebetween, on one of the main casing and the sub-casing.

7. A folding-type electronic device according to claim 6, wherein
the functional component is a structure unit that has a large-diameter portion at the center of the structure unit in an axial direction, and has small-diameter portions at both ends of the structure unit, and
the small-diameter portions at both ends are engaged with the pair of second bearings respectively.

8. The folding-type electronic device according to claim 4, wherein
the functional component is a rotation switch that is rotatably supported within at least a constant angular range by the pair of second bearing members.

9. A folding-type electronic device according to claim 8, wherein
the functional component consists of: a rotation unit that is rotatably supported within at least a constant angular range by the pair of second bearings; and a rotation detection sensor that is fixed to one of the main casing and the sub-casing, adjacent to the rotation unit.

10. A folding-type electronic device according to claim 4, wherein the functional component is supported by the pair of second bearings such that the functional component is not rotatable but is movable in an axial direction within a predetermined range.

11. A folding-type electronic device according to claim 4, wherein
the functional component is supported by the pair of second bearings such that the functional component is rotatable within at least a constant angular range and is also movable in an axial direction within a predetermined range.

12. A folding-type electronic device according to claim 1, wherein the functional component is an electric element such as a switch.

13. A folding-type electronic device according to claim 1, wherein the functional component is a communication element.

14. A folding-type electronic device according to any one of claim 1, wherein the functional component is an optical element.

15. A folding-type electronic device according to claim 1, wherein the functional component is an acoustic element.
